(19) United States
(12) Patent Application Publication
(10) Pub. No.: US 2003/0054905 A1
(43) Pub. Date: Mar. 20, 2003

(54) Monitoring computer system for court and field ball games

(76) Inventor: Willie A. King JR., Pompano Beach, FL (US)

Correspondence Address: John H. Oltman, Oltman, Flynn & Kubler, 915 Middle River Drive #415, Ft. Lauderdale, FL, 33304, US

(21) Appl. No.: 09/952,423

(22) Filed: Sep. 14, 2001

(51) Int. Cl. G06F 155/00

(52) U.S. Cl. 473/467; 700/91

(57) ABSTRACT

A computerized sensor system for monitoring a ball game played with a game ball by several players on a court or field includes a game monitoring computer containing a sensor signal identifying and processing program; a central receiver for receiving sensor signals and relaying the sensor signals to the computer; a score display mechanism operationally linked to the game monitoring computer to display information sent by the computer; a ball transmitter secured to the ball broadcasting a ball sensor signal; a player sensor/transmitter transmitting a player sensor signal to the central receiver identifying the team of the given player and sensing the presence of the ball transmitter within a detection radius; and court or field sensors secured relative to the court or field and correspondingly positioning above the court or field for monitoring the location of the ball and of a player having the ball. The system preferably additionally includes a goal sensor/transmitter, sensing the presence of the ball transmitter within a detection radius and thereupon transmitting a goal sensor signal to the central receiver indicating that the goal was achieved.

### FILING HISTORY

This application is based in part on the contents of Disclosure Document number 462,352 recorded on Sep. 20, 1999.

### BACKGROUND OF THE INVENTION

1. Field of the Invention

The present invention relates generally to the field of sports played on courts and fields. More specifically the present invention relates to a computerized sensor system for use in various ball games played on courts and fields involving several players, the system continually tracking in real time which of the players has the ball, confirming whether attempted point scoring has been successful and preferably automatically registering the score, and in the case of basketball also indicating whether a shot is made from inside or outside the three point line. Elements of the system are selected and located, and the computer program specially configured to be suitable for monitoring each is specific type of game. The system elements include a game monitoring computer, a scoreboard operationally linked to the game monitoring computer, a ball sensor/transmitter mounted to the game ball, a player sensor/transmitter secured to the clothing of each player identifying the given player team and optionally the specific player, a goal sensor/transmitter, and in some instances include a monitoring referee wristboard, and court or field sensors for securing to the court or field to monitor the location of a player having the ball relative to a certain region or zone of the court or field.

The sensor/transmitters and sensors preferably receive infrared signals and send radio wave signals to a receiver, although use of any other suitable sending and receiving signal waves is contemplated. They also send radio wave signals to spaced apart signal receiving antennas which are preferably provided adjacent to the court or field, which in turn transmit the signal to the computer. The signals sent to the computer from these receiving antennas indicates in real time the directions of each of the various players on the court or field, or simply the direction of the player having the ball, and the computer calculates the positions of the player or players and ball by triangulation. This together with scoring and other information is relayed by the computer in real time to the arena scoreboard and optionally to a referee wristboard for display in any of various convenient forms. It is preferred that the scoreboard simply show score and time numbers, while it is preferred that the wristboard show a representation of the court or field and the locations of players within the court or field.

2. Description of the Prior Art

In recent years a variety of boundary sensor systems have been developed for a number of sports. Yet none of these prior systems detects player and ball positions relative to important zones within a playing court or field and detects successful scoring attempts. Brace, U.S. Pat. No. 5,800,292, issued on Sep. 1, 1998 discloses a tennis court boundary detection system; Carmona, U.S. Pat. No. 5,059,944, issued on Oct. 22, 1991, teaches a tennis court boundary sensor; Supran, U.S. Pat. No. 4,432,058, issued on Feb. 14, 1984, reveals a micro-computer network systems for making and using automatic line-call decisions in tennis; Wexler, et al., U.S. Pat. No. 5,489,886, issued on Feb. 6, 1996, discloses an automatic line officiating system and method; Bowser, et al., U.S. Pat. No. 4,840,377, issued on Jun. 20, 1989, teaches an electrical tape boundary sensor apparatus; Hale, et al., U.S. Pat. No. 5,978,723, issued on Nov. 2, 1999, discloses an automatic identification of field boundaries in site-specific farming system; Bianco, U.S. Pat. No. 5,438,518, issued on Aug. 1, 1995, reveals a player positioning and distance finding system; Fanning, U.S. Pat. No. 5,259,625, issued on Nov. 9, 1993, teaches an apparatus and method for playing a court game; and Spademan, U.S. Pat. No. 4,447,968, issued on May 15, 1984, discloses a multidirectional dynamic fitting system for sport shoe.

It is thus an object of the present invention to provide a monitoring computer system for monitoring the positions of sports players and of the game ball or puck on a playing court or field in real time.

It is another object of the present invention to provide such a system which detects whether a score or shot is successfully executed and which automatically displays it on a display board, and optionally on a miniature board secured to the referee wrist with a watch strap, also referred to herein as a wristboard.

It is still another object of the present invention to provide such a system which detects the position of the player having the ball relative to any zone or region in a court or field.

It is finally an object of the present invention to provide such a system which is made up of system elements which are relatively inexpensive to manufacture and can be installed with only minimal to moderate expense and skill.

### SUMMARY OF THE INVENTION

The present invention accomplishes the above-stated objectives, as well as others, as may be determined by a fair reading and interpretation of the entire specification.

A computerized sensor system is provided for monitoring a ball game played with a game ball by several players on a court or field, including a game monitoring computer containing a sensor signal identifying and processing program; a central receiver for receiving sensor signals and relaying the sensor signals to the computer; a score display mechanism operationally linked to the game monitoring computer to display information sent by the computer; a ball transmitter secured to the ball broadcasting a ball sensor signal; a player sensor/transmitter transmitting a player sensor signal to the central receiver identifying the team of the given player and sensing the presence of the ball transmitter within a detection radius; and court or field sensors secured relative to the court or field and correspondingly positioning above the court or field for monitoring the location of the ball and of a player having the ball.

The system preferably additionally includes a goal sensor/transmitter, sensing the presence of the ball transmitter within a detection radius and thereupon transmitting a goal sensor signal to the central receiver indicating that the goal was achieved. The score display mechanism preferably includes a referee monitoring wristboard including a liquid crystal display and signal receiving mechanism receiving displaying player and ball position on a representation of the court or field. The score display mechanism preferably includes a scoreboard including a display panel and signal receiving mechanism receiving displaying player and ball position and score information.

The player sensor/transmitter optionally transmits a player sensor signal to the central receiver identifying the given player individually. For basketball, the goal sensor preferably is secured within the basket. The court or field includes a perimeter line and a region within the perimeter line, and the court sensors includes lower court sensors placed in rows along a grid underneath the court throughout the region within and along the perimeter line and correspondingly positioned upper court sensors secured above the lower court sensors.

The players wear player shoes and several player sensors preferably are secured to the player shoes. The several player sensors are preferably are distributed over the surface of each player shoe and are linked to a central shoe chip embedded in the sole of the shoe. Where the players wear player belts, at least some of the several player sensors optionally are secured to the player belts. A player belt sensor optionally is provided in the player belt buckle.

The system preferably additionally includes several spaced apart triangulating antennas receiving player sensor and ball transmitter signals and relaying player and ball direction information in real time to the central receiver for transmission into the computer for calculation of player and ball position information. The system preferably still further includes a three point shot green light operationally connected to the computer and illuminated only when the ball transmitter is within the detection radius of a player sensor/transmitter and the player is outside the perimeter line.

A computerized sensor system is provided for monitoring a boxing match played with a boxing gloves, in which boxers wear boxing trunks and jerseys, including a game monitoring computer containing a sensor signal identifying and processing program; a central receiver for receiving sensor signals and relaying the sensor signals to the computer; a score display system operationally linked to the game monitoring computer to display information sent by the computer; an impact sensitive glove sensor/transmitter system secured to the each glove and broadcasting a glove sensor signal indicating which boxing glove has delivered a blow; and an impact sensitive boxer clothing sensor/transmitter distributed over boxer clothing identifying where boxing gloves strike and sending signals to the central receiver for automatic scoring of body blows.

### BRIEF DESCRIPTION OF THE DRAWINGS

Various other objects, advantages, and features of the invention will become apparent to those skilled in the art from the following discussion taken in conjunction with the following drawings, in which:

FIG. 1 is a perspective view of a basketball court fitted with the various system elements.

FIGS. 2-5 are side, bottom, broken away perspective top and rear views, respectively, of a basketball player shoe fitted with the system sensors and transmitter chip.

FIG. 6 is a front view of a player wearing a belt having the player sensor/transmitter in the belt buckle, indicating with a arrows the detection radius of the player sensor transmitter.

FIGS. 8-11 are views of a basketball fitted with the ball transmitter element, FIG. 9 being a broken away cross-sectional view of a ball skin.

FIG. 12 is a perspective view of a preferred court or field sensor.

FIG. 13 is a side view of a football equipped with the various elements of the ball transmitter of the present invention.

FIG. 14 is a side view of a player shoe showing the several sensors, with part of the heal area shown broken away, revealing the embedded transmitter chip.

FIG. 15 is a top view of a football playing field equipped with the various system elements.

FIG. 16 is a front view of the optional referee wristboard having the preferred game information display.

FIG. 17 is a front view of a boxer jersey and trunks fitted with the grid of sensor wires and clothing sensors, and of the boxing gloves fitted with glove sensors.

FIG. 18 is a rear view of a boxer jersey, showing the half shirt design made up of a harness formed of straps releasably joined by buckles.

### DETAILED DESCRIPTION OF THE PREFERRED EMBODIMENTS

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Reference is now made to the drawings, wherein like characteristics and features of the present invention shown in the various FIGURES are designated by the same reference numerals.

Preferred Embodiments

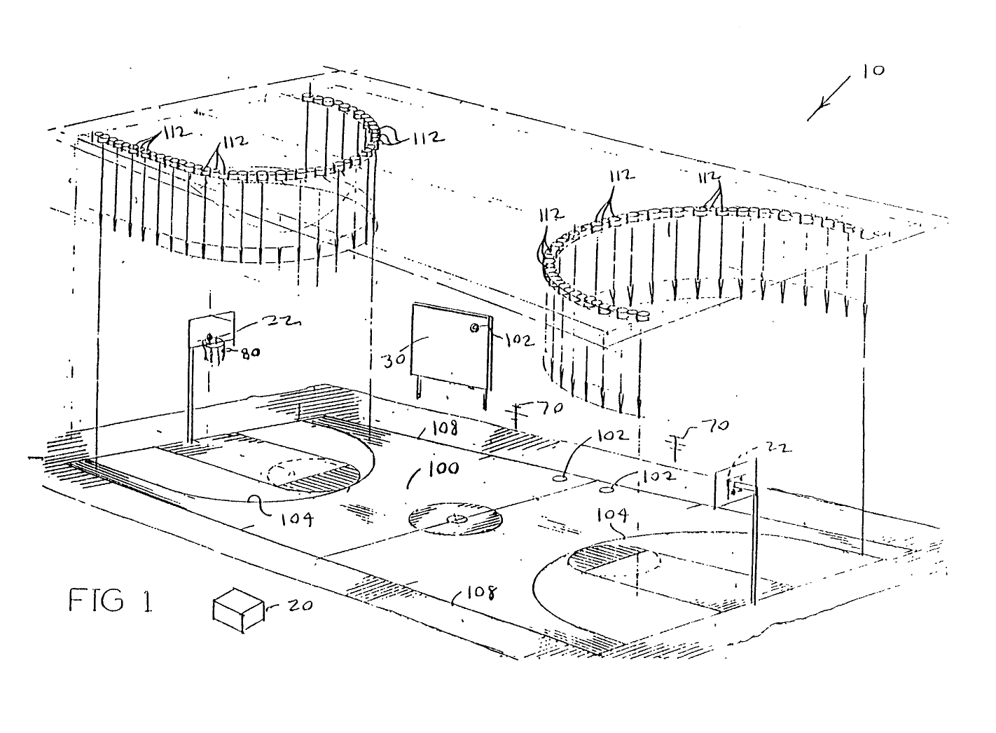

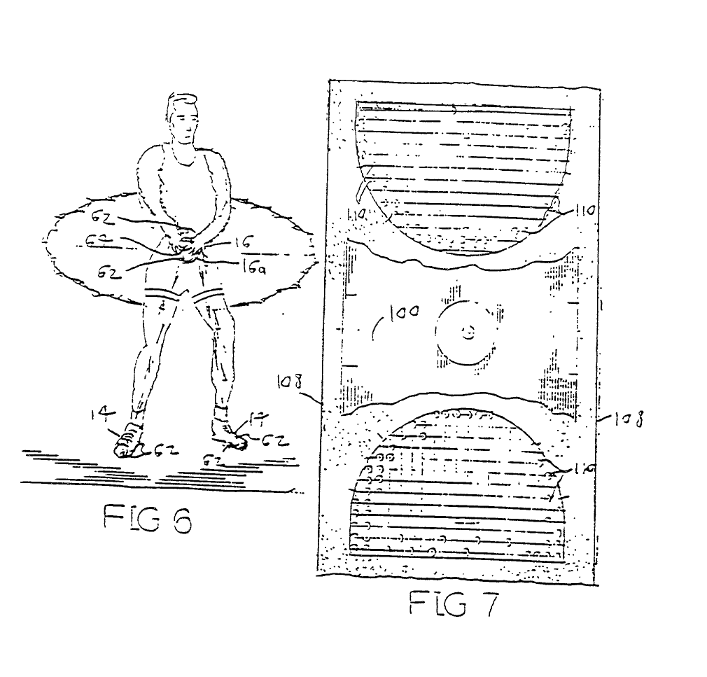

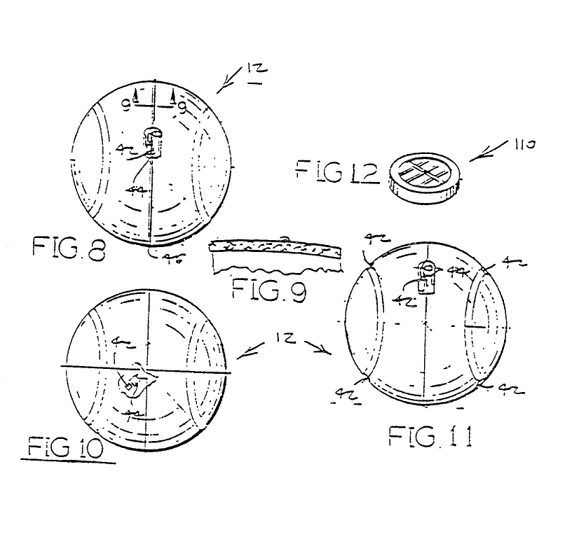

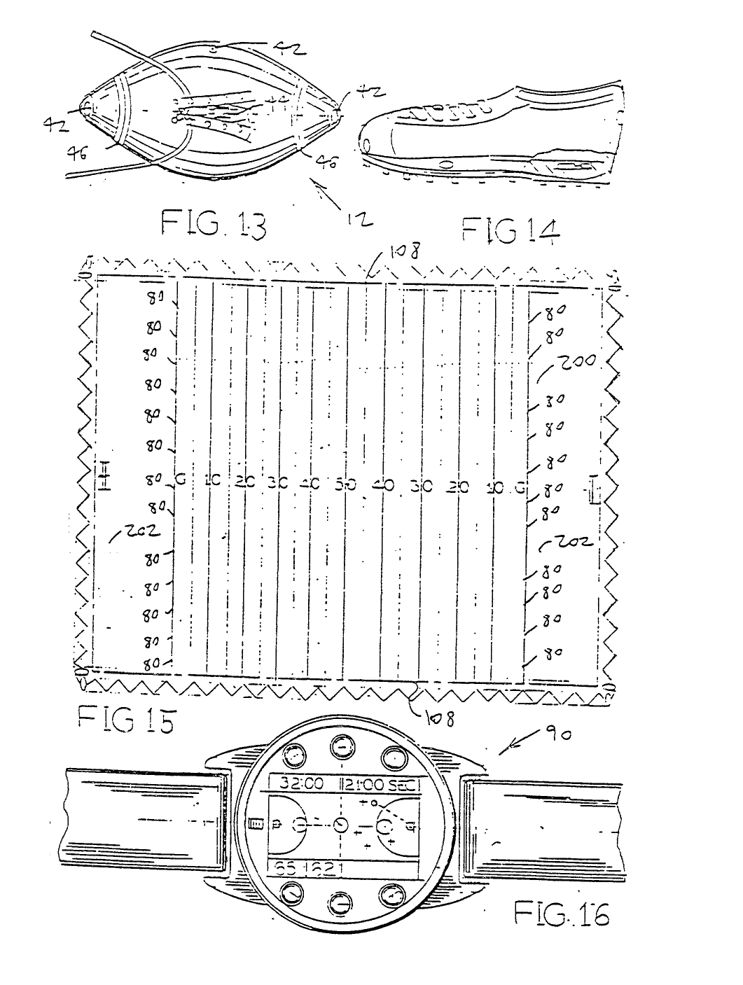

Referring to FIGS. 1-18, a computerized sensor system 10 is disclosed for monitoring of various ball games played on game courts 100 or game fields 200 involving several players and a game ball 12. See FIGS. 1 and 15. The players each wear player shoes 14 and optionally player belt 16 with belt buckles 16a. System 10 continually tracks in real time which of the players has the ball 12, confirms whether attempted point scoring has been successful and preferably automatically registers the score, and in the case of basketball also indicates whether a shot is made from inside or outside the three point line. Elements of system 10 are selected and located, and a computer program is specially configured to be suitable for monitoring each specific type of game.

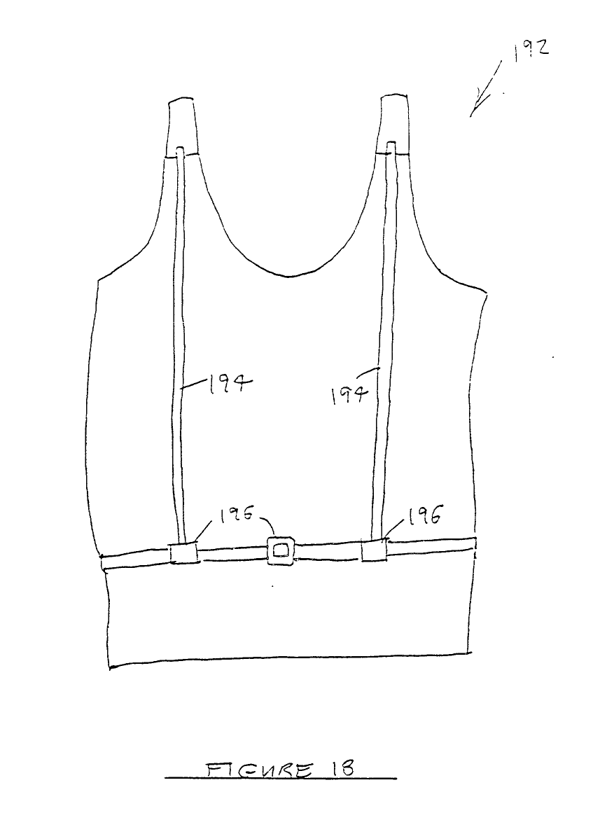

System 10 elements include a game monitoring computer 20, a game scoreboard 30 linked to game monitoring computer 20, a ball transmitter 40 secured to and preferably within ball 12, a player sensor/transmitter 60 identifying the given player team and optionally the given player individually, a goal sensor/transmitter 80, and in some instances include a referee monitoring wristboard 90, and court lower sensors 110 for embedding in a game court 100 and court upper sensors 112 correspondingly positioning above the court 100, to be individually aligned with each court lower sensor 110 or field sensors 130 mounted in cones, for monitoring the location of a player having the ball 12 relative to a certain region or zone. The various sensors 40, 60, 80, 110, 112 and 130 send radio wave signals to a central receiver built into the computer 20 and to receiving antennas 70 which relay direction information in real time to the game monitoring computer 20 which calculates player locations through triangulation, and this information is relayed by the computer 20 in real time to the arena scoreboard 30 and optionally to a referee wristboard 90 for display in any of various suitable forms. See FIG. 16. It is preferred that the scoreboard 30 simply shows score and time numbers, while it is preferred that the wristboard 90 shows a representation of the court 100 or field 200 and the locations of players within the court or field, the players of one team being identified by a special mark such as an “x” and the players of the other team by a different special mark such as an “o”. Of course, either of these display versions or other display versions may be shown on either the scoreboard 30 or the wristboard 90.

To permit scores to be correctly registered when the teams switch sides of a court, automatic switches 22 are provided in sensor circuits of the goals which switch and reverse the “x” and “o” designations of the teams. These automatic switches 22 are operated by the monitoring computer 20.

Basketball

A preferred application of the system 10 is for the game of basketball. For basketball, the ball transmitter 40 is embedded under the outer skin of the ball 12, the goal sensor/transmitter 80 is placed within the basket hoop or netting 106, and lower court sensors 110 are placed in rows along a grid underneath the court 100 floor boards throughout the region within and along the three point line, hereinafter referred to as the perimeter line 104, with correspondingly positioned, one to one aligned upper court sensors 112 secured directly above the lower court sensors 110, preferably near the arena ceiling. For each player, a player sensor/transmitter 60 is provided in the player belt 16 or shoe 14. Shoe mounted player sensor/transmitters 60 including sensors 62 provided at various points along the sides, top and bottom of the player shoes 14 which are linked to a central shoe transmitter chip 64 embedded in the sole of the shoe 14, and alternatively or additionally a player belt mounted player sensor/transmitter 60 is provided in the belt buckle 16a. The player sensor/transmitters 60 each have a four foot detection radius, for detecting the presence of the ball transmitter 40 within this detection radius to indicate which player has the ball 12. When the ball transmitter 40 is within the player sensor radius, the player sensor/transmitter 60 transmits a signal to the central receiver which sends the signal by wire into the game monitoring computer 20, telling the computer 20 which player has the ball 12 at any given moment.

Spaced apart signal receiving antennas 70 transmit signals to the computer 20 for player and ball 12 position calculation, and for relaying to the scoreboard 30 and referee wristboard 90.

A three point shot green light 102 is provided on the scoreboard 30 or elsewhere in the arena and remains lighted when any player has the ball 12 and is located outside the perimeter line 104, so that a shot made by the player from his immediate a position will be known to be worth three points. For the system 10 to light the green light 102, the ball 12 must be within the detection radius of a player sensor/transmitter 60, indicating that the given player has the ball 12, and the player sensor/transmitter 60 and the ball 12 must be located either on or outside the perimeter line 104. Should the ball 12 be located outside the detection radius of all player sensor/transmitter 60, the green light 102 is shut off, indicating that a shot made by that player at that moment is not a three point shot. If the ball 12 is within any given player/transmitter 60 detection radius, but the given player sensor/transmitter 60 or the ball transmitter 40 is inside the perimeter line 104, the green light 102 is shut off, again indicating that a shot made by that player at that moment is not a three point shot. The court sensors 110 and 112 are referred to as negative sensors because they negate the operation of the green light 102 by sensing entry of the ball 12 or player sensor/transmitter 60 having the ball 12 are inside the region marked by the perimeter line 104. Court upper and lower sensor/transmitters 114 and 116 are optionally placed along out-of-bounds lines 108 to indicate whether a player having the ball 12 has crossed out of bounds.

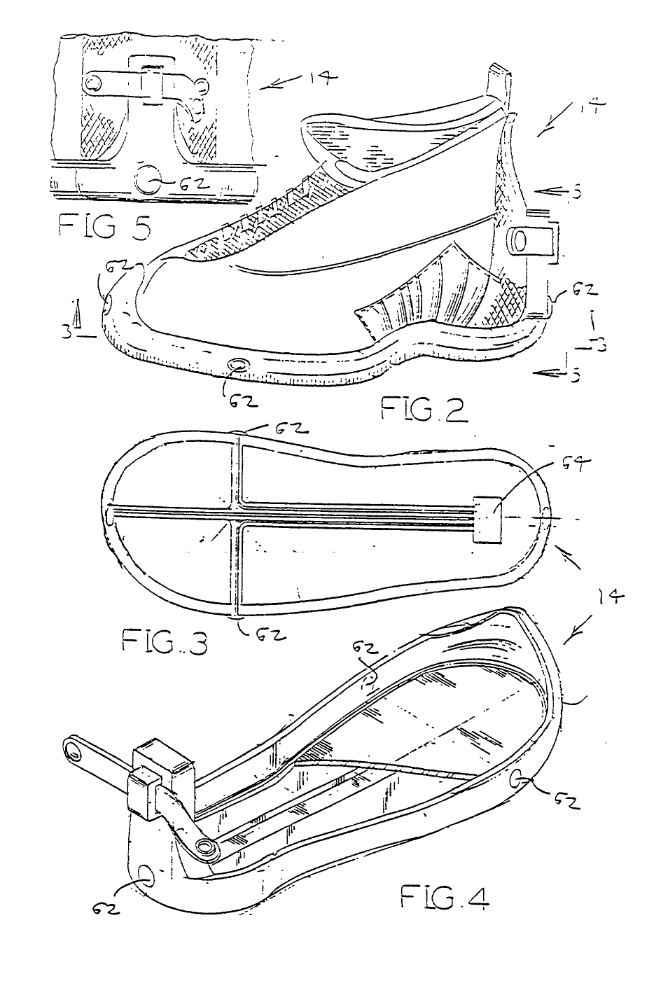

The preferred type of sensor is an infrared sensor and the preferred type of transmitter is a radio wave transmitter. The placement of the multiple individual sensors and of the central transmitter chip 64 in a player shoe(s) 14 preferably are positioned as shown in FIGS. 2-5. The preferred placement of the sensor and of optical fibers in the game ball 12 are as shown in FIGS. 8-11. A ball computer chip 44 and ball fiber wires 46 are placed between ball 12 leather layers and secured with a special glue, to be connected to several and preferably four ball transmitters 42 distributed over the ball 12 outer surface. The ball computer chip 44 is on the outside surface of the inter air tube lobe 48 and secured with a special glue.

A shooting fowl button 92 is provided on the wristboard 90. As a player shoots two one point fowl shots, the computer 20 provides up to 10 seconds to shoot the next shot. The referee places the shooting player in the proper position first, and then hits the button 92 on the wristboard 90 to start the first 10 second shot time. Then the computer 20 gives two or three seconds for the ball 12 to be returned to the player, and then gives a second 10 second shot time for throwing the second fowl shot. Shooting fowls are automatically detected while non-shooting fowls are visually noted by the referee directly, who just blows his whistle.

New Basketball Playing Method

A new playing method is provided which is essentially an overtraining game. The game is played for 39 minutes; there is a 21 second shot clock; the rim is ten feet, ten inches high; the perimeter is 25 feet from the basket; court dimensions are 99 feet by 55 feet. A score shot from inside the perimeter line counts one point and a score shot from outside the perimeter line counts two points.

Football

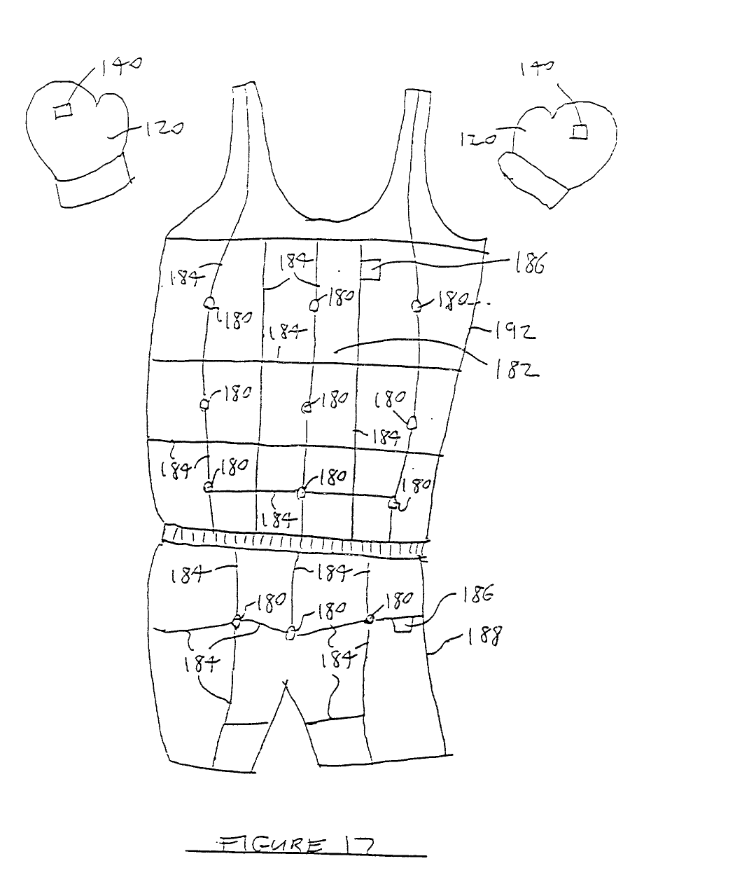

Another preferred application of the system 10 is for the game of football. For football, the ball transmitter 40 is embedded under the outer skin of the ball 12, a plurality of goal sensor/transmitters 80 are placed within cones 82 within both of the field end zones 202. See FIG. 15. Once again, the player sensors 62 are located within player shoes 14 as disclosed for use in basketball games. See FIG. 14. Out-of-bounds cone mounted sensors 114 are optionally placed along the field boundaries to detect when a player with the ball 12 runs out of bounds.

The ball transmitter 40 is embedded in the ball 12, including a ball computer battery chip 44 underneath the ball laces, a ball electronic sensitive device 42 at each ball 12 longitudinal end and a ball fiber optic wire 46 extending along each circumferential white stripe. See FIG. 13. The air lobe is indicated by reference numeral 48.

Once again, the player sensor transmitters 60 have a detection radius of four feet to identify which player has the ball 12, or simply to identify the team to which the player having the ball 12 belongs. The system 10 optionally includes player location receiving antennas 70 which relay real time location information to the game monitoring computer 20.

The use of system for other court and field games is contemplated. These include but are not limited to hockey, volleyball, and baseball.

Boxing

Another application of the system 10 is for the game of boxing. For boxing, the glove transmitter 140 is embedded within both gloves of each boxer, under the outer skin of each glove 120. A grid of clothing sensors 180 are secured over the front panel 182 of the boxer jersey 192 and trunks 188 and are interconnected by a network of sensor wires 184 which are connected to a clothing transmitter 186 secured to the boxer jersey 192 and trunks 188. See FIG. 17. The rear of the jersey 192 preferably is a half shirt or harness formed of straps 194 releasably joined by buckles 196. See FIG. 18. The clothing sensors 180 are individually identifiable so that the impact of a glove 120 against a clothing sensor 180 identifies not only the particular glove 120 which strikes the clothing but also identifies the region of the boxer body which received the blow, so that accurate scoring can be achieved. A glove 120 impact to a region of the boxer trunks 188 automatically registers as a low blow and a penalty. Thus body shot scoring is mostly automatic, which head shots can be seen easily and recorded by the judges.

While the invention has been described, disclosed, illustrated and shown in various terms or certain embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

I claim as my invention:

1. A computerized sensor system for monitoring a ball game played with a game ball by a plurality of players on a court, comprising:
a game monitoring computer containing a sensor signal identifying and processing program;
a central receiver for receiving sensor signals and relaying the sensor signals to said computer;
score display means operationally linked to the game monitoring computer to display information sent by said computer;
a ball transmitter secured to the ball broadcasting a ball sensor signal;
a player sensor/transmitter transmitting a player sensor signal to the central receiver identifying the team of the given player and sensing the presence of the ball transmitter within a detection radius;
and court sensors secured relative to the court and correspondingly positioning above the court for monitoring the location of the ball and of a player having the ball.

2. The system of claim 1, additionally comprising a goal sensor/transmitter, sensing the presence of the ball transmitter within a detection radius and thereupon transmitting a goal sensor signal to the central receiver indicating that the goal was achieved.

3. The system of claim 1, wherein said score display means comprises a referee monitoring wristboard comprising a liquid crystal display and signal receiving means receiving displaying player and ball position on a representation of the court.

4. The system of claim 1, wherein said score display means comprises a scoreboard comprising a display panel and signal receiving means receiving displaying player and ball position and score information.

5. The system of claim 1, wherein said player sensor/transmitter transmits a player sensor signal to said central receiver identifying the given player individually.

6. The system of claim 1, wherein said goal sensor is secured within the basket.

7. The system of claim 1, wherein the court comprises a perimeter line and a region within the perimeter line, and wherein said court sensors comprise lower court sensors placed in rows along a grid underneath the court throughout the region within and along the perimeter line and correspondingly positioned upper court sensors secured above said lower court sensors.

8. The system of claim 1, wherein the players wear player shoes and wherein a plurality of said player sensors are secured to the player shoes.

9. The system of claim 8, wherein a plurality of said player sensors are distributed over the surface of each player shoe and are linked to a central shoe chip embedded in the sole of the shoe.

10. The system of claim 1, wherein the players wear player belts and wherein a plurality of said player sensors are secured to the player belts.

11. The system of claim 10, a player belt sensor is provided in the player belt buckle.

12. The system of claim 1, additionally comprising a plurality of spaced apart triangulating antennas receiving player sensor and ball transmitter signals and relaying player and ball direction information in real time to said central receiver for transmission into said computer for calculation of player and ball position information.

13. The system of claim 1, additionally comprising a three point shot green light operationally connected to said computer and illuminated only when the ball transmitter is within the detection radius of a player sensor/transmitter and the player is outside the perimeter line.

14. A computerized sensor system for monitoring a ball game played with a game ball by a plurality of players on a field, comprising:
a game monitoring computer containing a sensor signal identifying and processing program;
a central receiver for receiving sensor signals and relaying the sensor signals to said computer;
score display means operationally linked to the game monitoring computer to display information sent by said computer;
a ball transmitter secured to the ball broadcasting a ball transmitter signal;
a player sensor/transmitter transmitting a player sensor signal to the central receiver identifying the team of the given player and sensing the presence of the ball transmitter within a detection radius;
and field sensors secured relative to the field and correspondingly positioning above the field for monitoring the location of the ball and of a player having the ball.

15. The system of claim 14, additionally comprising a goal sensor/transmitter, sensing the presence of the ball transmitter within a detection radius and thereupon transmitting a goal sensor signal to the central receiver indicating that the goal was achieved.

16. The system of claim 14, wherein said score display means comprises a referee monitoring wristboard comprising a liquid crystal display and signal receiving means receiving displaying player and ball position on a representation of the field.

17. The system of claim 14, wherein said score display means comprises a scoreboard comprising a display panel and signal receiving means receiving displaying player and ball position and score information.

18. The system of claim 14, wherein said player sensor/transmitter transmits a player sensor signal to said central receiver identifying the given player individually.

19. The system of claim 14, wherein said goal sensor is secured within the basket.

20. The system of claim 14, wherein the players wear player shoes and wherein a plurality of said player sensors are secured to the player shoes.

21. A computerized sensor system for monitoring a boxing match played with a boxing gloves, in which boxers wear boxing trunks and jerseys, comprising:
a game monitoring computer containing a sensor signal identifying and processing program;
a central receiver for receiving sensor signals and relaying the sensor signals to said computer;
score display means operationally linked to the game monitoring computer to display information sent by said computer;
an impact sensitive glove sensor/transmitter means secured to the each glove and broadcasting a glove sensor signal indicating which boxing glove has delivered a blow;
and impact sensitive boxer clothing sensor/transmitter means distributed over boxer clothing identifying where said boxing gloves strike and sending signals to said central receiver for automatic scoring of body blows.

22. A method of playing basketball, comprising the steps of:
playing for thirty nine minutes;
providing a 21 second shot clock;
providing a basket rim having a height of ten feet, ten inches;
providing a perimeter line along a radius of 25 feet from the basket;
providing court dimensions of 99 feet by 55 feet;
awarding one point for a score shot from inside the perimeter line;
and awarding two points for a score shot from outside the perimeter line.
